(19) United States
(12) Patent Application Publication
(10) Pub. No.: US 2025/0243919 A1
(43) Pub. Date: Jul. 31, 2025

(54) HANDGUN MAGAZINE SPRING

(71) Applicant: HS Produkt D.O.O., Karlovac (HR)

(72) Inventor: Marijo Špine, Karlovac (HR)

(21) Appl. No.: 19/049,824

(22) Filed: Feb. 10, 2025

Related U.S. Application Data
(63) Continuation of application No. 29/848,508, filed on Aug. 3, 2022, now Pat. No. D061783.
Application No. 29/848,508 is a continuation of application No. 29/708,605, filed on Oct. 8, 2019, now abandoned.
Application No. 29/708,605 is a continuation of application No. 35/505,373, filed on Jul. 7, 2018, now Pat. No. D862631.

(51) Int. Cl. F16F 1/04; F41A 9/70

(52) U.S. Cl. CPC F16F 1/047; F16F 2228/066; F16F 2238/026; F41A 9/70

(57) ABSTRACT

The present disclosure provides a handgun magazine spring comprising a plurality of coils including a top coil, a bottom coil, and intermediate coils wherein the intermediate coils each include opposing curved segments and a straight segment and wherein transition segments extend between the curved segments of adjacent intermediate coils. The intermediate coils include small intermediate coils and large intermediate coils. The straight segments of the coils are parallel to each other. The transition segments between the intermediate coils, however, are oblique with other transition segments.

### CROSS-REFERENCE TO RELATED APPLICATION

This application is a continuation of U.S. patent Ser. No. 29/848,508 filed Aug. 3, 2022 which is continuation of U.S. Design Pat. No. 29/708,605 filed Oct. 8, 2019, which is a continuation of U.S. Design Pat. Serial No. 35/505,373 (now U.S. Pat. D862,631) filed Jul. 7, 2018, which are hereby incorporated by reference.

### BACKGROUND OF THE INVENTION

The present invention pertains generally to a handgun magazine spring.

### SUMMARY OF THE INVENTION

A handgun magazine spring may comprise a wire defining a plurality of coils. The plurality of coils may have individual coils defined at least by a first curved segment, a second curved segment and a straight segment between the first and second curved segments. The straight segments of the plurality of coils may be positioned along a first side of the spring. In some embodiments, the straight segments may be parallel to one another. Along a second side of the spring opposite the first side, the wire may define a plurality of transition segments extending between curved segments of adjacent coils. The plurality of transition segments may extend in directions oblique to one another.

In some embodiments, the plurality of coils may comprise large individual coils and small individual coils. The individual coils of the large individual coils may be adjacent to another large individual coil to form groups of large coils. In some instances, a group of small individual coils may be positioned between the groups of large coils.

In some aspects, the transition segments may extend in directions oblique to one another extend between groups of large and small coils. In additional examples, the straight segments between the first and second curved segments of the small individual coils may be positioned laterally inward relative to the straight segments between the first and second curved segments of the large individual coils.

In some embodiments, the first and second curved segments of the small individual coils may be positioned laterally inward of the first and second curved segments of the large individual coils.

In certain embodiments, a handgun magazine spring may comprise a plurality of coils including a top coil, a bottom coil, and intermediate coils. Each intermediate coil may include opposing curved segments and a straight segment, and wherein the intermediate coils may be different sizes so that the intermediate coils include small intermediate coils and large intermediate coils. Transition segments may be positioned between curved segments of adjacent coils of the plurality of coils. The straight segment of each intermediate coil of the plurality of coils may be parallel to the straight segments of each of the other intermediate coils of the plurality of coils. Each transition segment may be nonparallel with respect to other transition segments of the transition segments.

In certain aspects, the transition segments may be positioned at an oblique angle with respect to the straight segments of the plurality of coils. Additionally, the transition segments may each be located on a same side of the spring. In some instances, a transition segment between adjacent large intermediate coils may be parallel to the straight segments of the adjacent large intermediate coils.

In certain aspects, the straight segments of the intermediate coils may each be located on a same side of the spring opposite the transition segments. In some embodiments, the bottom coil may be larger than the top coil.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a handgun magazine spring.

FIG. 2 is a left side view of the handgun magazine spring.

FIG. 3 is a back view of the handgun magazine spring.

FIG. 4 is a top view of the handgun magazine spring.

FIG. 5 is a bottom view of the handgun magazine spring.

### DETAILED DESCRIPTION OF THE INVENTION

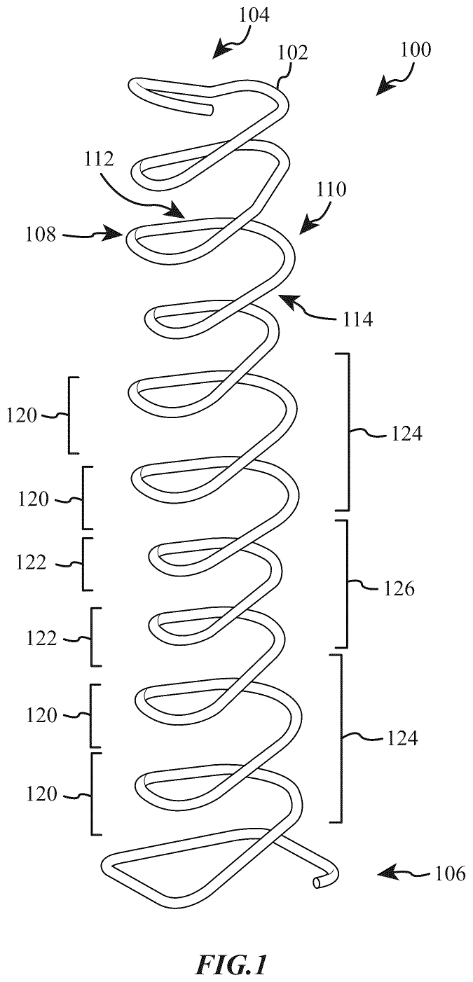

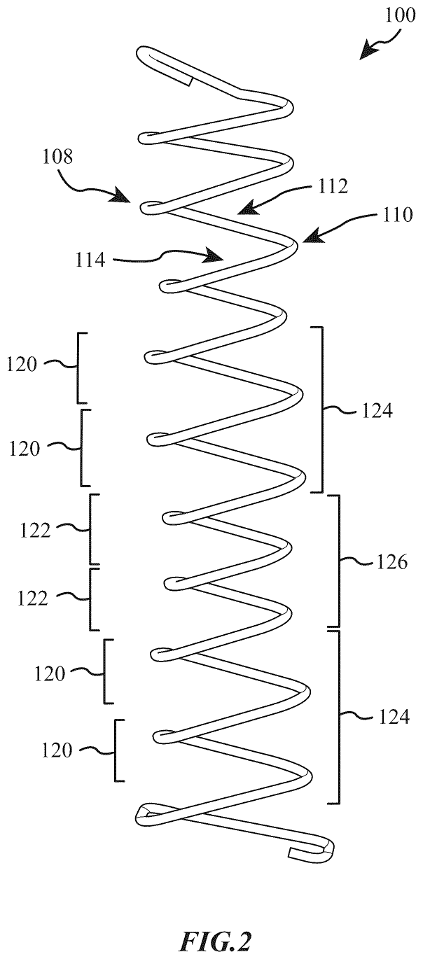

The handgun magazine spring 100 is illustrated in FIGS. 1-5. The spring comprises a wire 102 helically wound to define a plurality of spaced apart coils positioned between a top end 104 and a bottom end 106 of the spring. Individual coils of the plurality of coils are defined at least by a first curved segment 108, a second curved segment 110, and a straight segment 112 extending between the first and second curved segments. Between curved segments of adjacent coils are transition segments 114.

The plurality of coils includes large coils 120 and small coils 122. Individual coils of the large coils are adjacent to another large individual coil to form groups 124 of large coils. Positioned between groups of large coils is a group of small individual coils 126.

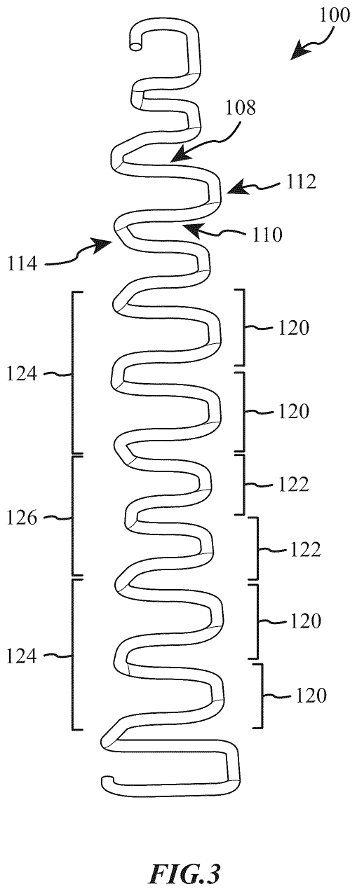

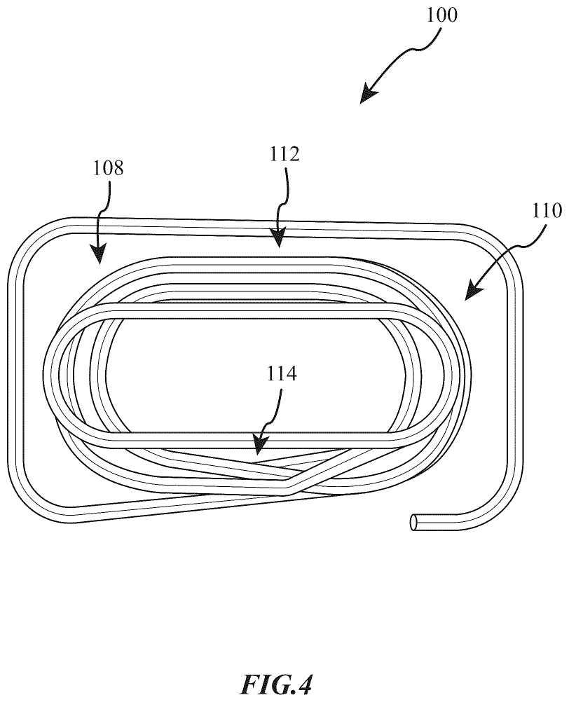

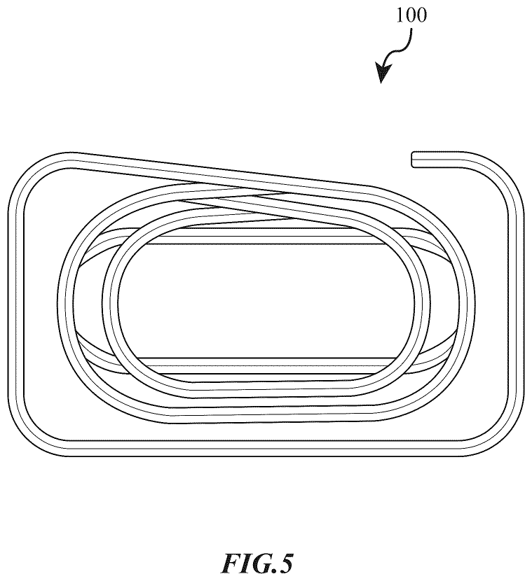

As can be seen in FIG. 3, the transition segments extend in directions oblique to one another and are on one side of the spring. The straight segments are parallel to one another and are on an opposite side of the spring. As seen in FIG. 3 and also in FIGS. 4 and 5, straight segments between the first and second curved segments of small individual coils are positioned laterally inward relative to the straight segments between the first and second curved segments of the large individual coils. The first and second curved segments of the small individual coils are also positioned laterally inward of the first and second curved segments of the large individual coils.

1. A handgun magazine spring, comprising:
a wire defining a plurality of coils;
said plurality of coils having individual coils defined at least by a first curved segment, a second curved segment and a straight segment between said first and second curved segments;
wherein said straight segments of said plurality of coils are positioned along a first side of said spring;
wherein along a second side of said spring opposite said first side, said wire defines a plurality of transition segments extending between curved segments of adjacent coils; and
wherein said plurality of transition segments extend in directions oblique to one another.

2. The handgun magazine spring of claim 1, wherein the straight segments are parallel to one another.

3. The handgun magazine spring of claim 1, wherein the plurality of coils comprises large individual coils and small individual coils.

4. The handgun magazine spring of claim 3, wherein individual coils of the large individual coils are adjacent to another large individual coil to form groups of large coils.

5. The handgun magazine spring of claim 4, wherein positioned between the groups of large coils is a group of small individual coils.

6. The handgun magazine spring of claim 5, wherein the transition segments extending in directions oblique to one another extend between groups of large and small coils.

7. The handgun magazine spring of claim 6, wherein the straight segments between said first and second curved segments of the small individual coils are positioned laterally inward relative to the straight segments between said first and second curved segments of the large individual coils.

8. The handgun magazine spring of claim 7, wherein the first and second curved segments of the small individual coils are positioned laterally inward of the first and second curved segments of the large individual coils.

9. A handgun magazine spring, comprising:
a wire defining a plurality of coils;
said plurality of coils having individual coils defined at least by a first curved segment, a second curved segment and a straight segment between said first and second curved segments;
wherein said straight segments of said plurality of coils are positioned along a first side of said spring;
wherein along a second side of said spring opposite said first side, said wire defines a plurality of transition segments extending between curved segments of adjacent coils;
wherein the plurality of coils comprises large individual coils and small individual coils;
wherein individual coils of the large individual coils are adjacent to another large individual coil to form groups of large coils; and
wherein positioned between the groups of large coils is a group of small individual coils.

10. The handgun magazine spring of claim 9, wherein the transition segments extending in directions oblique to one another extend between groups of large and small coils.

11. The handgun magazine spring of claim 10, wherein the straight segments between said first and second curved segments of the small individual coils are positioned laterally inward relative to the straight segments between said first and second curved segments of the large individual coils.

12. The handgun magazine spring of claim 11, wherein the first and second curved segments of the small individual coils are positioned laterally inward of the first and second curved segments of the large individual coils.

13. The handgun magazine spring of claim 12, wherein said plurality of transition segments extend in directions oblique to one another.

14. The handgun magazine spring of claim 13, wherein the straight segments are parallel to one another.

15. A handgun magazine spring comprising:
a plurality of coils including a top coil, a bottom coil, and intermediate coils, wherein each intermediate coil includes opposing curved segments and a straight segment, and wherein the intermediate coils are different sizes so that said intermediate coils include small intermediate coils and large intermediate coils;
transition segments positioned between curved segments of adjacent coils of said plurality of coils;
wherein the straight segment of each intermediate coil of said plurality of coils is parallel to the straight segments of each of the other intermediate coils of said plurality of coils;
wherein each transition segment is nonparallel with respect to other transition segments of said transition segments.

16. The handgun magazine spring of claim 15, wherein said transition segments are positioned at an oblique angle with respect to said straight segments of said plurality of coils.

17. The handgun magazine spring of claim 15, wherein said transition segments are each located on a same side of the spring.

18. The handgun magazine spring of claim 15, wherein said straight segments of said intermediate coils are each located on a same side of the spring opposite said transition segments.

19. The handgun magazine spring of claim 15, wherein said bottom coil is larger than said top coil.

20. The handgun magazine spring of claim 15, wherein a transition segment between adjacent large intermediate coils is parallel to said straight segments of said adjacent large intermediate coils.
